(19) United States
(12) Patent Application Publication
(10) Pub. No.: US 2014/0194166 A1
(43) Pub. Date: Jul. 10, 2014

(54) TELEPHONE GLOVE

(71) Applicant: HIFUN SRL, Milan (IT)

(72) Inventor: Guido FALCK, Milano (IT)

(73) Assignee: HIFUN SRL, Milan (IT)

(21) Appl. No.: 13/771,836

(22) Filed: Feb. 20, 2013

(30) Foreign Application Priority Data
Jan. 8, 2013 (IT) MI2013A000014

(51) Int. Cl. H04M 1/02

(52) U.S. Cl. CPC H04M 1/0202
USPC 455/567

(57) ABSTRACT

The present invention relates to a glove comprising a transceiver module for operationally connecting to at least a second device, and further comprising at least a speaker and at least a microphone that are operationally connected to the transceiver module to transmit and to receive audio signals, in particular voice signals, exchanged with the second device; the glove further comprises at least one vibrating element operationally connected to the transceiver module, wherein the transceiver module is configured to generate an activation signal upon receiving an operating request from the second device, and wherein the vibrating element performs at least one mechanical vibration in response to the activation signal.

### PRIORITY/CROSS-REFERENCE TO RELATED APPLICATIONS

This application claims the benefit of Italian Patent Application n. MI2013A000014 having title “Guanto Telefonico” filed on 8, Jan. 2013, the disclosure of which is incorporated by reference.

### BACKGROUND OF THE INVENTION

The present invention relates to a glove comprising a transceiver module, a microphone and a speaker, for audio and/or voice communications.

At present, devices are known suitable to interface with cell phones and smartphones, such as Bluetooth® earphones, which allow users to have a telephone conversation by cell phone or smartphone, without having to hold it in one's hand, but simply interacting with the earphone. To that end, a Bluetooth® earphone comprises a microphone and a speaker and have such a shape as to allow the users to wear it near his/her ear.

Nowadays also other devices are known which simplify the interaction of the user with the cell phone or with the smartphone, such as telephone gloves. Such telephone gloves are made of textile fibres and house inside them a Bluetooth® electronic technology which converts them into remote earphones.

Once the telephone glove is paired with the telephone and is interfaced with it, the user may perform various actions (refuse, accept, etc.) in relation to an incoming call, by means of appropriate buttons positioned on the glove itself.

Telephone gloves known in the art comprise a microphone on the little finger and a speaker on the thumb, so that the user, once a call is received, may bring the hand to his/her head and talk by means of the glove making the classic “telephone” hand gesture.

Telephone gloves known in the art, however, have some drawbacks, since the signalling of incoming calls is essentially delegated to the telephone. Because of this, for example, when the user is far from his/her phone, or he/she is using the phone with a silent profile, or, simply, he/she keeps the phone in a pocket of his/her coat while being outdoors (a frequent situation for using telephone gloves), the user himself/herself may be unable to notice the incoming call, risking to miss it. In general, the interaction of the user with the telephone by means of the telephone gloves known in the art, is at present not completely satisfying.

### SUMMARY OF THE DISCLOSURE

An object of the present invention is to provide a telephone glove which solves some of the problems of the prior art.

In particular, an object of the present invention is to provide a telephone glove that is able to improve the interaction of the user with a device, typically a cell phone or a smartphone, interfaced with it.

A further object of the present invention is to provide a telephone glove that allows a user to become promptly aware of an incoming call on his/her cell phone or smartphone.

A further object of the present invention is to provide a light and practical telephone glove, having functionalities that improve its usage and its pleasantness of interaction with a user.

These and other objects are achieved by means of a glove according to the appended claims, which are an integral part of the present description.

An idea at the basis of the present invention is to provide a glove comprising a transceiver module suitable to be operationally connected to at least a second device, and further comprising at least one speaker and at least one microphone that are operationally connected to the transceiver module in order to transmit and receive audio signals, in particular voice signals, exchanged with the second device, which is typically a cell phone or a smartphone; the glove further comprises at least one vibrating element operationally connected to the transceiver module, wherein the transceiver module is configured to generate an activation signal upon receiving an operating request from the second device, and wherein the vibrating element is configured to perform at least one mechanical vibration in reply to the activation signal.

Thus, the glove emits a sensible signal that is easily perceived by the user who wears the glove, to bring the incoming call, or other situations that require an appropriate signalling, to his/her attention. The user interaction with the second device, such as a phone, to which the glove is operationally connected, is thus facilitated; at the same time, the glove pleasantness and convenience of use and the user satisfaction are improved.

Preferably, the glove comprises a substantially flat frame housing the transceiver module; the frame is inserted in a flap or in a pocket inside the glove and the vibrating element is rigidly constrained to a wall of the frame. Thus the vibrating element is in a favourable position, so that the mechanical vibration it emits is easily perceived by the user, improving the effectiveness of the sensible signalling.

Preferably, the transceiver module comprises at least an electronic board, and the vibrating element is substantially button-shaped in order to be interposed between the wall to which it is rigidly constrained and the electronic board. Preferably, the board to which the vibrating element is constrained faces towards the inside of the glove, so that it is proximal to the hand of the user. Thus the vibrating element is in an even more favourable position, so that the mechanical vibration it emits is easily perceived by the user, improving the effectiveness of the sensible signalling.

Preferably, the flap or the pocket wherein the frame is positioned, is at the cuff of the glove, preferably on the back of the latter. Thus the vibrating element is in a favourable position, so that the mechanical vibration it emits is easily perceived by the user, improving the effectiveness of the sensible signalling. Moreover, the interaction of the user with the glove improves, since buttons possibly associated to the transceiver module of the glove would be easily reached.

Preferably, the glove houses a battery for supplying power to the transceiver module and to the vibrating element; the battery is substantially flat and is housed in the frame, being interposed between the wall to which the vibrating element is constrained and the electronic board, preferably on the same plane as the vibrating element. Thus a more compact and portable device is obtained.

Preferably, the vibrating element comprises an electric motor and a mass being eccentric with respect of the rotation axis of the motor itself, in order to realize a light and robust vibrating element.

Preferably, the transceiver module is configured to be connected to second devices, such as cell phones or smartphones, by means of the Bluetooth protocol; the operating request is thus performed when the signal of an incoming call on the second device is received.

Preferably, the glove comprises a fabric having conductive fibres, in order to allow its usage on capacitive touchscreens when a user wears it; preferably conductive fibres are located on the end of the fingers of the glove, at least on thumb and forefinger.

Preferably, the vibrating element is activated in order to perform the mechanical vibration in an intermitting way, according to a predetermined duty cycle, improving the sensory perception of the user and at the same time reducing the battery consumption.

Preferably, in glove the microphone is located at the end of the little finger, and the speaker is located at the end of the thumb, so that the user can speak by means of the glove by making the classic “telephone” hand gesture.

Other particular and advantageous aspects will become more clear from the following detailed description.

### BRIEF DESCRIPTION OF THE DRAWINGS

Some preferred and advantageous embodiments are described by way of non-limiting examples, with reference to the appended figures, wherein:

FIG. 1 schematically shows a glove that is object of the present invention.

FIG. 2 shows in greater detail the electronic elements of the glove of FIG. 1.

FIG. 3 schematically shows a partially disassembled bottom view of the electronic elements of FIG. 2.

FIG. 4 schematically shows a lateral section of the glove of FIG. 1.

The figures show different aspects and embodiments of the present invention and, where appropriate, structures, components, materials and/or similar elements in different figures are indicated by the same reference numbers.

### DETAILED DESCRIPTION

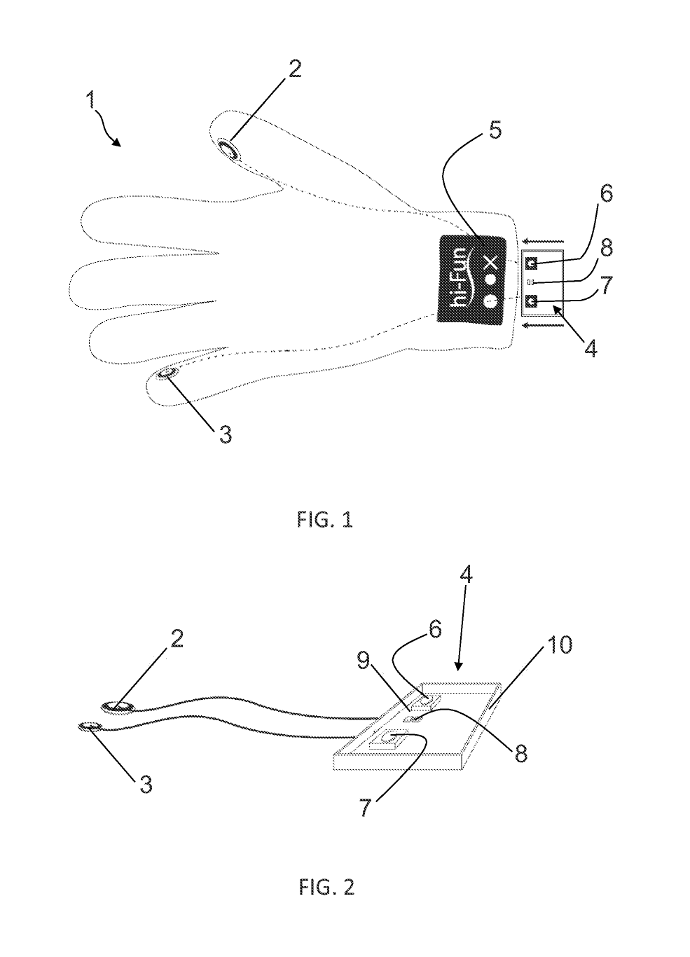

FIG. 1 shows a glove 1 according to the present invention. The glove 1, intended in a non-limiting way to be worn on a left hand, comprises a speaker 2 and a microphone 3. The speaker 2 is positioned preferably in the thumb, facing inwards towards the hand; the microphone 3 is positioned preferably in the little finger, facing inwards towards the hand. The user may thus speak by means of the glove 1, by bringing it close to the head and making the classic “telephone” hand gesture.

To perform the conversation, the glove 1 comprises a transceiver module 4, that is represented for increased visibility out of the glove 1, and intended to be inserted in the flap of the cuff of the glove 1, or in another appropriate pocket, in the area identified by the graphical element 5. The transceiver module 4 is thus, in operating conditions, inserted in the glove 1 as shown by the two arrows of FIG. 1, and operationally connected to the speaker 2 and the microphone 3 by means of appropriate connections schematized in FIG. 1 by dashed lines.

The transceiver module 4 comprises a user interface by means of which a user may signal to take a call, to refuse a call, to make a call, for example to the same number as the last call, etcetera. For this purpose, the transceiver module 4 comprises a first button 6, a second button 7, and a signalling light 8, preferably a multicoloured LED light. By means of the LED light 8, the user interface of the glove 1 is suitable for signalling particular situations to the user, for example the switching-on of the glove, the connection to a telephone device, a low level of the battery charge, etc.

Preferably, the first button 6 corresponds to a switching on button, while the second button 7 corresponds to a multifunction button, wherein a long and/or an alternated pressure of the latter makes the glove 1 perform different operations.

The interface buttons are in particular configured to occupy precise positions, indicated in the graphical element, once that the transceiver module 4 has been inserted in the appropriate pocket or flap of the glove 1.

Preferably, in operating conditions, the transceiver module 4 is on the back of the glove 1, in order to simplify the access to the buttons 6 and 7 and to improve the visibility of the warning light 8.

The glove 1 is made of fabric, preferably of knitted fabric, and comprises conductive textile fibres, that are suitable for conducting electric charge to the hand of a user who wears the glove 1. Thus the glove 1 can be used preferably also to interact with capacitive touchscreens, such as the screens of cell phones or smartphones to which the glove 1 is typically paired.

Preferably, the conductive portion is localized in specific areas of the glove 1, the area at the end of the forefinger and the area at the end of the thumb, respectively, in order to perform “multi-touch” functions on touchscreen devices.

FIG. 2 shows in greater detail the electronic elements of the glove of FIG. 1.

The transceiver module comprises an electronic board 9, preferably a printed circuit board (PCB), whose dimensions are preferably 35 mm×25 mm. Such PCB 9 integrates the Bluetooth chipset, the battery management system, the buttons 6 and 7 and the warning light 8, furthermore the PCB 9 integrates a socket (not shown) with an electrical connection, for example a micro USB socket, for charging the battery, and also an antenna (not shown) for example a planar printed antenna.

The transceiver module 4 is housed within an appropriate frame 10, preferably made of plastic material.

The frame 10 is thus suitable to house both the PCB 9 and the further elements that will be described below in greater detail.

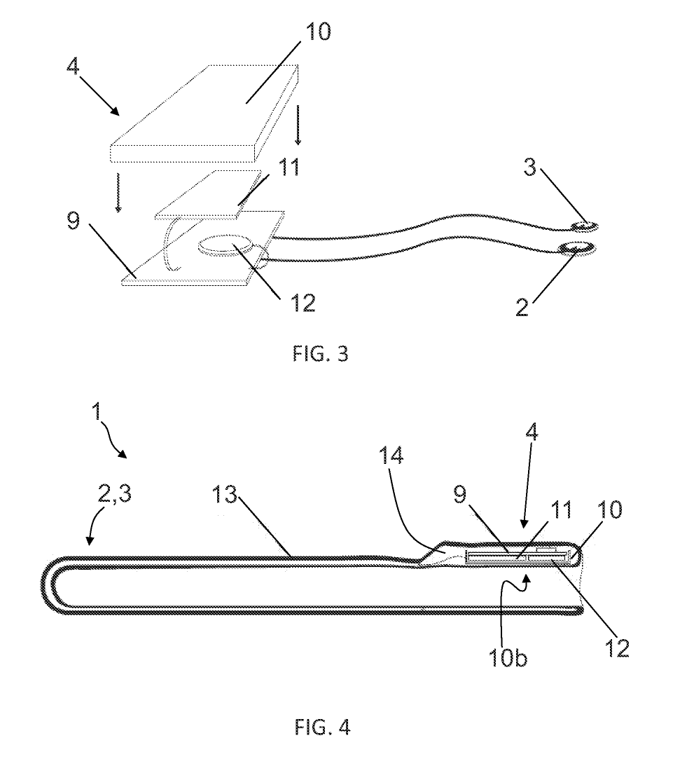

FIG. 3 schematically shows a partially disassembled bottom view of the electronic elements of FIG. 2.

The glove comprises a substantially flat battery 11, electrically connected to the PCB 9, of the lithium rechargeable type.

The glove comprises also a vibrating element 12, such as for example a substantially button-shaped electric motor, mechanically connected to an eccentric mass in relation to the rotation axis of the engine that, when rotating, generates a mechanical vibration perceivable by an user.

The vibrating element 12 is thus operationally and electrically connected to the PCB 9, and is thus suitable to be selectively power supplied by the battery 11, when the control logic of the glove so provides, as will be described below in greater detail.

Both the PCB 9 and the battery 11 and the vibrating element 12 are preferably housed inside the frame 10, which is preferably box-shaped. Thus, inserting the other electric and electronic elements described above in the frame 10, it is possible to realize the transceiver module 4 previously described.

Preferably, the vibrating element 12 is rigidly constrained to a wall of the frame 9, for example by gluing or by other suitable mechanical constraint. Thus, the vibrations of the vibrating element 12 are transmitted to the whole frame 10. At the same time, preferably, the battery 11 and the PCB are constrained to the frame 10, in a non-rigid way, with appropriate degrees of freedom and joints, in order to avoid being negatively influenced by the vibrations of the vibrating element. Anyway, the battery 11 could simply be glued to the frame 10.

Preferably, the vibrating element 12 is interposed between the lower side of the PCB 9 and the frame 10, next to the battery 9. Such assembly formed by battery 11, PCB 9 and vibrating element 12, is thus placed in the frame 10 in order to be protected from bumps and stresses, contributing also to the mechanical stiffness of the assembly.

FIG. 4 schematically shows a lateral section of the glove of FIG. 1, wherein it is possible to notice that the fabric 13 of the glove 1 defines a substantially pocket-shaped flap 14, inside which the transceiver module 4 is inserted. It is also possible to notice that the substantially button-shaped vibrating element 12 is interposed between a wall 10b of the frame 10 and the PCB 9, and that the wall 10b faces inwards toward the glove 1, in order to be as near as possible to the hand or to the wrist of an user wearing the glove 1.

The battery 11 is substantially flat, and is housed in the frame 10 being interposed between the wall 10b and the PCB 9, preferably being on the same plane as the vibrating element 12.

Thus the glove 1 integrates a system to bring to the user's attention an incoming call, by means of a controlled vibration. To that end, the transceiver module 4 is configured to generate an activation signal when it receives a determined request from the device to which the glove 1 is operationally connected, from example from a cell phone or a smartphone connected to the glove 1 by means of the Bluetooth protocol. The vibrating element 12 is thus configured to perform a mechanical vibration in reply to the activation signal provided by the transceiver module.

To that end, when an incoming call is signalled, a door of the microcontroller on the PCB 9, which supervises the functions of the device, switches to a “high” logical state, causing the switching of a transistor which closes the circuit between the battery 9 and the electric motor of the vibrating element 12. Thus a consequent vibration is provoked which thus brings the incoming call to the user's attention.

At this point, the user can decide to accept or to refuse the call by means of the buttons 6 and 7 placed in correspondence of the graphical element 5 on the upper part of the glove 1, facing towards the user.

Preferably, the transceiver module 4 is configured to generate the activation signal of the vibration in a controlled way, in order to perform an intermittent mechanical vibration, according to a predetermined duty cycle wherein vibration phases and idle phases are alternated (wherein the electric motor is not power supplied). Thus the vibration is made more evident to the user, and electric energy provided by the battery 11 is saved.

Preferably, an appropriate duty cycle for the vibration has been defined in order to have 1.5 s of activation followed by 1.5 s of stop.

Preferably, the connection of the glove 1 to a second device such as, for example, a cell phone or a smartphone, is made by means of Bluetooth protocol with a hands-free profile of the mono-type (audio) and bi-directional type (communication).

Advantageously, the use of the Bluetooth protocol allows an operative connection between the glove 1 and the associated device, which works at distances up to 5 m and above, allowing the user to be distant from his/her phone, to the advantage of a higher flexibility.

By considering the description of the present invention referring to preferred and advantageous embodiments, it is apparent for the person skilled in the art that further modifications and alternative embodiments of the invention are possible.

For example, the glove could be provided with a different number of speakers and microphones, and they could be positioned in other parts of the glove, such as palm, other fingers, etc. Similarly, the glove could be provided with hands-free systems by means of appropriate speakers and microphones.

Obviously, a glove according to the present invention can also be made to be worn on the right hand, or on the left or right hand without distinction. Such glove may have 5 fingers, or be a glove wherein two or more fingers share the same space.

The battery supplying power to the glove and the transceiver module could be positioned in a different way, or be of the replaceable and non-rechargeable type, being for example a button battery, or one or more batteries, for example of the AAA type.

What is claimed is:

1. A glove comprising a transceiver module for operationally connecting to at least a second device, and further comprising at least one speaker and at least one microphone that are operationally connected to the transceiver module for transmitting and receiving audio signals, in particular voice signals, exchanged with the second device, wherein said glove further comprises at least one vibrating element operationally connected to the transceiver module, wherein the transceiver module is configured to generate an activation signal upon receiving an operating request from the second device, and wherein the vibrating element performs at least a mechanical vibration in response to said activation signal.

2. The glove as claimed in claim 1, further comprising a substantially flat frame wherein said transceiver module is housed, said glove further comprising a flap or a pocket inside which said frame is inserted, wherein said vibrating element is rigidly constrained to a wall of said frame.

3. The glove as claimed in claim 2, wherein the glove comprises a cuff, and wherein said frame is positioned at the cuff of said glove.

4. The glove as claimed in claim 3, wherein the glove comprises a back, and wherein said frame is positioned on the back of said glove.

5. The glove as claimed in claim 2, wherein said transceiver module comprises at least an electronic board, wherein said vibrating element is substantially button-shaped and is interposed between said wall and said electronic board, wherein said wall faces towards the inside of said glove, so that it is proximal to the hand of a user wearing said glove.

6. The glove as claimed in claim 5, further comprising a battery for supplying power to said transceiver module and to said vibrating element, wherein said battery is substantially flat and is housed in said frame being interposed between said wall and said electronic board, on the same plane as said vibrating element.

7. The glove as claimed in claim 5, wherein the glove comprises a cuff, and wherein said frame is positioned at the cuff of said glove.

8. The glove as claimed in claim 7, wherein the glove comprises a back, and wherein said frame is positioned on the back of said glove.

9. The glove as claimed in claim 7, further comprising a battery for supplying power to said transceiver module and to said vibrating element, wherein said battery is substantially flat and is housed in said frame being interposed between said wall and said electronic board, on the same plane as said vibrating element.

10. The glove as claimed in claim 1, wherein said vibrating element comprises an electric motor and a mass being eccentric with respect of the axis of rotation of said electric motor.

11. The glove as claimed in claim 1, wherein said transceiver module is configured to be connected to said second device by means of a Bluetooth protocol, and wherein said operating request is provided upon receiving an incoming call signal on said second device.

12. The glove as claimed in claim 1, wherein the glove comprises fingers having ends, and wherein said glove comprises a fabric having conductive fibres, so as to allow its usage on capacitive touchscreens when a user wears it, said conductive fibres being located at least on the end of at least some fingers of said glove.

13. The glove as claimed in claim 1, wherein said transceiver module is configured to generate an activation signal in order to perform said mechanical vibration in an intermitting way, according to a predetermined duty cycle.

14. The glove as claimed in claim 1, wherein the glove comprises a little finger having an end and a thumb having an end, wherein said microphone is positioned on the end of the little finger of said glove, and wherein said speaker is positioned on the end of the thumb of said glove.

15. The glove as claimed in claim 1, further comprising a substantially flat frame wherein said transceiver module is housed, said glove further comprising a flap or a pocket inside which said frame is inserted, wherein said vibrating element is rigidly constrained to a wall of said frame, wherein said vibrating element comprises an electric motor and a mass being eccentric with respect of the axis of rotation of said electric motor.

16. The glove as claimed in claim 1, further comprising a substantially flat frame wherein said transceiver module is housed, said glove further comprising a flap or a pocket inside which said frame is inserted, wherein said vibrating element is rigidly constrained to a wall of said frame, wherein said transceiver module comprises at least an electronic board, wherein said vibrating element is substantially button-shaped and is interposed between said wall and said electronic board, wherein said wall faces towards the inside of said glove, so that it is proximal to the hand of a user wearing said glove, wherein said vibrating element comprises an electric motor and a mass being eccentric with respect of the axis of rotation of said electric motor.

17. The glove as claimed in claim 1, further comprising a substantially flat frame wherein said transceiver module is housed, said glove further comprising a flap or a pocket inside which said frame is inserted, wherein said vibrating element is rigidly constrained to a wall of said frame, wherein said transceiver module is configured to be connected to said second device by means of a Bluetooth protocol, and wherein said operating request is provided upon receiving an incoming call signal on said second device.

18. The glove as claimed in claim 1, further comprising a substantially flat frame wherein said transceiver module is housed, said glove further comprising a flap or a pocket inside which said frame is inserted, wherein said vibrating element is rigidly constrained to a wall of said frame, and wherein said transceiver module comprises at least an electronic board, wherein said vibrating element is substantially button-shaped and is interposed between said wall and said electronic board, wherein said wall faces towards the inside of said glove, so that it is proximal to the hand of a user wearing said glove, wherein said transceiver module is configured to be connected to said second device by means of a Bluetooth protocol, and wherein said operating request is provided upon receiving an incoming call signal on said second device.

19. The glove as claimed in claim 1, wherein the glove comprises fingers having ends, said glove further comprising a substantially flat frame wherein said transceiver module is housed, said glove further comprising a flap or a pocket inside which said frame is inserted, wherein said vibrating element is rigidly constrained to a wall of said frame, said glove comprising a fabric having conductive fibres, so as to allow its usage on capacitive touchscreens when a user wears it, said conductive fibres being located at least on the end of at least some fingers of said glove.

20. The glove as claimed in claim 1, wherein the glove comprises fingers having ends, further comprising a substantially flat frame wherein said transceiver module is housed, said glove further comprising a flap or a pocket inside which said frame is inserted, wherein said vibrating element is rigidly constrained to a wall of said frame, wherein said transceiver module comprises at least an electronic board, wherein said vibrating element is substantially button-shaped and is interposed between said wall and said electronic board, wherein said wall faces towards the inside of said glove, so that it is proximal to the hand of a user wearing said glove, said glove comprising a fabric having conductive fibres, so as to allow its usage on capacitive touchscreens when a user wears it, said conductive fibres being located at least on the end of at least some fingers of said glove.
